(19) United States
(12) Patent Application Publication
(10) Pub. No.: US 2004/0239982 A1
(43) Pub. Date: Dec. 2, 2004

(54) Method of cropping a digital image

(76) Inventor: John-Paul J Gignac, Ontario (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/487,995

(22) PCT Filed: Aug. 29, 2002
(86) PCT No.: PCT/CA02/01335

(30) Foreign Application Priority Data
Aug. 31, 2001 (CA) 2356573

(51) Int. Cl. G06K 15/02; H04N 1/387; G06F 3/12; G06F 15/00

(52) U.S. Cl. 358/1.15; 382/282; 358/453; 358/1.18; 715/527

(57) ABSTRACT

Method of cropping digital images and ordering of the cropped digital images advantageously uses the Print Wizard application of a computer operating system. The method modifies the Print Wizard application to include a cropping tool application written in a client sided scripted language which modifies the Print Wizard application to provide a user controlled cropping tool for imulating the cropping of digital images. The operating system can receive the cropping application by downloading of the cropping application from a photographic print server when the personal computer initiates contact with the print server. It is also possible that the Print Wizard has previously been modified by having the cropping application as part of the Print Wizard application initially or having previously been modified. The modified Print Wizard application allows modification by simulating a form of cropping and deriving cropping instructions associated with particular digital images. The user then instructs the server with respect to his order which includes the capability of including cropping instructions with respect to any of the digital images. In a preferred aspect of the invention, the cropping application uses a fixed aspect ratio for varying the cropping tool in accordance with a print size previously indicated by the user for that particular digital image or for the digital prints as a group. Preferably the cropping tool is written in JAVASCRIPT. This particular method and program has particular application for operating systems which have a web browser type approach for the operation thereof. The invention may also be used to prepare images for display on devices such as cell phones, PDA's, and digital picture frames.

### FIELD OF THE INVENTION

The present invention relates to systems and methods for the printing of digital images. In particular, the invention relates to an on line system and method for ordering prints of digital images and making available to the user a simple, effective cropping tool.

### BACKGROUND OF THE INVENTION

The use of computer networks as a tool to place orders for digital output from personal computers and similar devices dates back to the mid-eighties with a product by Management Graphics Inc (MGI), of Toronto, commercially known as “DIAL-A-SLIDE™”.

DIAL-A-SLIDE enabled a personal computer user to create a graphical image (often using an associated program known as “PC Slide™”) and then, using an attached modem, dial a central facility where a PDP-11 with a series of modems and phone lines would receive the call, establish a data link, recognize the user, and then accept transmission of the image and instructions for output onto photographic film or paper. A limitation of this approach was that in order to offer new features to its users, MGI was required to produce and distribute new versions of “DIAL-A-SLIDE” (the “custom client software”) and the customer would then be required to perform a subsequent installation of the new version. In the mid-nineties, a conceptually similar system know as “FOTOWIRE™” was launched in Europe, this time using the Internet to form the link between the custom client software and a variety of remote processing facilities. All such systems, however, pose the significant problem of upgrades—it is difficult for the vendor to offer new features, seasonal products, and bug releases as customers are slow to upgrade the client software and do not enjoy being inconvenienced with numerous upgrade requirements.

Web browsers and the Internet offered new possibilities to vendors and one of the best known approaches first offered in the late nineties was known as “PHOTONET™”. PHOTONET initially approached the market with a process whereby the customer would take a roll of film to a nearby photofinishing retailer who, in turn, would process the roll, digitize the images, and then upload such images to one of a number of web servers. The customer could then access the images by entering a simple identification code into the web pages hosted by PHOTONET. While viewing the images, reprints could be ordered through a standard web browser interface. Because PHOTONET and similar services offered by firms such as TELEPIX™ displayed the reprint order forms through a standard web browser interface, they did not need to develop custom client software and were easily able to offer new product options, including seasonal products and service enhancements through web server software enhancements without the need for the customer to change any installed software—essentially, the web browser interface standardized all clients with a very rich set of functions that the service provider could draw upon as required by changing code on the web servers.

As digital cameras and scanners increased consumer access to digitized images, the number of consumers wishing to send such images directly to a photofinisher started to increase rapidly, particularly in the early 2000's. While the vendors deploying custom client software had, from the outset, an effective method for uploading images from the customer as part of the order process, vendors using standard web browser clients with server-side software assuming all high-resolution images resided on the server prior to the launch of an order process, had more difficulty. The simple approach was to simply require the customer to first upload the images, either directly through a web browser, or through a small custom client application. Once uploaded, the existing web server code would then enable reprint orders in exactly the same fashion as for those images which had been uploaded from photofinishing lab roll upload.

This simple approach, however, left the web-based reprint services at a disadvantage relative to the custom client software reprint services. While it was harder for the custom clients software services to offer the product and service diversity of the web-based approaches, such custom client software enabled these services to defer the time-consuming image upload step to the end of the reprint order process. Customers using the web-based services had to upload images first, then add order details—in the process, customer impatience with the upload step would either cut-back their original order plans, or, in some cases, never actually get to the order step having waited many minutes, or, with higher resolution images, many hours for the upload step to complete before the actual print order details could be entered.

Operating systems for personal computers continue to evolve and many of the techniques used in web browsers are now-used throughout the operating system. It continues to be a primary focus of such operating systems to simplify the steps required of a user to complete a particular task and to integrate the operating system with a host of business services available over the worldwide web.

Digital cameras continue to grow in popularity and allow the user to review and manipulate the digital images using specialized software. Traditional film based cameras also allow for the user to select digital images as an inexpensive option in addition to traditional development.

The original digital images are relatively high resolution and require substantial bandwidth to transmit the high resolution images over a network such as the INTERNET. For this reason, it is desirable to only transmit these images and to manipulate the images when economically justified.

The BETA version of the Window XP™ operating system includes an online Print Ordering Wizard which presents to the user a series of companies that provide for the printing of high quality photographs from digital images. Thus, within the operating system, there is an online Print Ordering Wizard which provides a series of steps to simplify the ordering of online prints. The actual high resolution digital images may reside on the personal computer of the user or on a print server of one of the online printing companies or on a separate digital photographic server that allows users to store their images in electronic photo albums on these servers.

In the case where the high resolution digital images reside on the personal computer, the Windows XP print wizard is designed to defer the upload of images until after the order data has been completed by the user. The wizard is also designed such that the majority of pages are served from a remote web server—in essence, the print wizard is an encapsulated version of a standard web browser. Thus, the wizard offers the benefits of the custom client software approach noted above (in that the tedious upload of images can be deferred until after the order details have been entered) and the web-based server side software (the ability to vary product offerings without the need to upgrade client software).

However, the existing systems for the online ordering of prints via a print wizard fail to provide the user with the ability to manipulate their digital images as part of the print ordering process. Basically, these online print wizards have merely allowed the user to select which digital images to be printed and allow the user to select the print size and orientation. Existing web-based server side software has failed to recognize that it is possible within such a wizard context to significantly manipulate local images using local processing in conjunction with server-side control before such images are actually uploaded to the server at the end of the online print wizard order process.

Further, there remains a need to provide a simple online print ordering arrangement which accommodates increased user control in the online printing of digital images.

### SUMMARY OF THE INVENTION

A method of cropping a digital image and ordering of the cropped image comprises the steps of using a personal computer equipped with an operating system which includes a print wizard application to initiate contact with a remote print server connected to the personal computer via a computer network, downloading from the photographic print server, a cropping tool written in a client sided scripted language which modifies the print wizard application to provide a user control cropping tool for cropping a digital image, displaying on the personal computer a digital image and the cropping tool, receiving user instructions from the print wizard and derived from the cropping tool to modify the displayed digital image and selectively obscuring a cropped portion of the digital image to clearly display the remaining cropped digital image, receiving user instructions signals from the print wizard to order a print of the remaining cropped digital image, and transmitting order instructions to the remote print server including cropping instructions of the cropping tool.

According to an aspect of the invention, the method includes the step of having the print server print the cropped digital image.

According to yet a further aspect of the invention, the method includes the step of uploading the original digital image to the print server as part of the order instructions.

In yet a further aspect of the invention, the original digital image is uploaded to the print server from the personal computer. Optionally, the cropping information could be used by an enhanced Print Ordering Wizard (not currently available either on XP or elsewhere) to automatically reduce the resolution and region of the original digital image uploaded. For example, if an original image was generated by a 4 megapixel camera, yet during the print order process, the user cropped just a small area of the image for printing on 4×6 inch paper, less than one quarter of the image data is actually relevant to the ordered print and such information could be transmitted to an enhanced Print Ordering Wizard at some stage after cropping but before upload so that the Wizard could selectively upload only the region of interest and only at a resolution, as specified by the remote print service, required for the given print size.

In yet a further aspect of the invention, the cropping tool is written in JAVASCRIPT.

In yet a further aspect of the invention, the cropping tool corresponds to client sided scripted events controlled by movement of a mouse of the personal computer.

In yet a further aspect of the invention, the cropping tool displays a cropping frame having a fixed aspect ratio which is adjusted in size and location by movements of the mouse.

In yet a further aspect of the invention, the method includes the user selecting the fixed aspect ratio based on a selected print size.

In yet a further aspect of the invention, the method includes the step of the user selecting within the print wizard a desired print orientation (portrait or landscape) or rotation for best visual cropping.

In yet a further aspect of the invention, the method is carried out within the operating system Windows XP™.

In yet a further aspect of the invention, the method is carried out by a personal computer which is a cell phone or PDA device.

According to yet a further aspect of the invention, the cropping tool displays the cropped region as a translucent region overlying the digital image.

In yet a further aspect of the invention, the method includes modifying of the operating system to include as part thereof and within the print wizard, the cropping tool. With this embodiment, there is no requirement to download the cropping tool to the personal computer as the operating system of the personal computer already has within the print wizard application the cropping tool.

In yet a further aspect of the invention, the method allows the end user to manipulate and crop a digital image using movements of the mouse within an HTML page.

In yet a further aspect of the invention, the cropping tool produces a cropping instruction which uses positioning information on the HTML page which with the positioning of the digital image on the page effectively defines the regions to be cropped and the desired image to be printed.

In yet a further aspect of the invention, the original digital image is converted into an alternate image file format compatible for display within the print wizard.

### BRIEF DESCRIPTION OF THE DRAWINGS

Preferred embodiments of the invention are shown in the drawings, wherein:

FIG. 1 shows a digital image;

FIG. 2 shows a cropped digital image;

FIG. 3 shows the digital image of FIG. 2 with the cropping tool being initiated;

FIG. 4 shows the cropping tool enlarging the area of interest;

FIG. 5 shows the new cropped image;

FIG. 6 shows the outline of a digital image space in a HTML page and various position points which are used by the cropping tool; and

FIGS. 7 through 25 are screen shots showing the use of the Print Ordering Wizard and cropping tool.

### DETAILED DESCRIPTION OF THE PREFERRED EMBODIMENTS

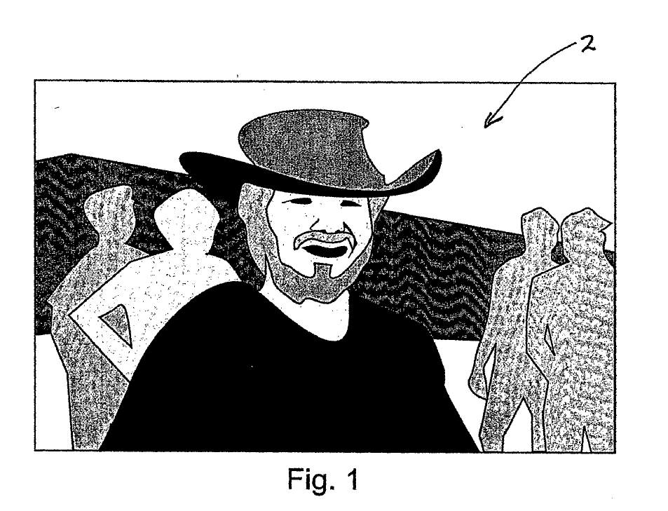

FIG. 1 shows a digital image 2 which could reside on a user's personal computer or a community digital photographic server or perhaps has the high resolution image thereof residing on a print server. The digital image 2 used by the personal computer can be of reduced resolution with only the high resolution copy being used when it is desired to actually print the modified image. Therefore, the digital image 2 may in effect be a proxy of a high resolution image residing either on that computer or somewhere else. In most cases there would be a series of digital images but the cropping of the images would be described with respect to the image of FIG. 1.

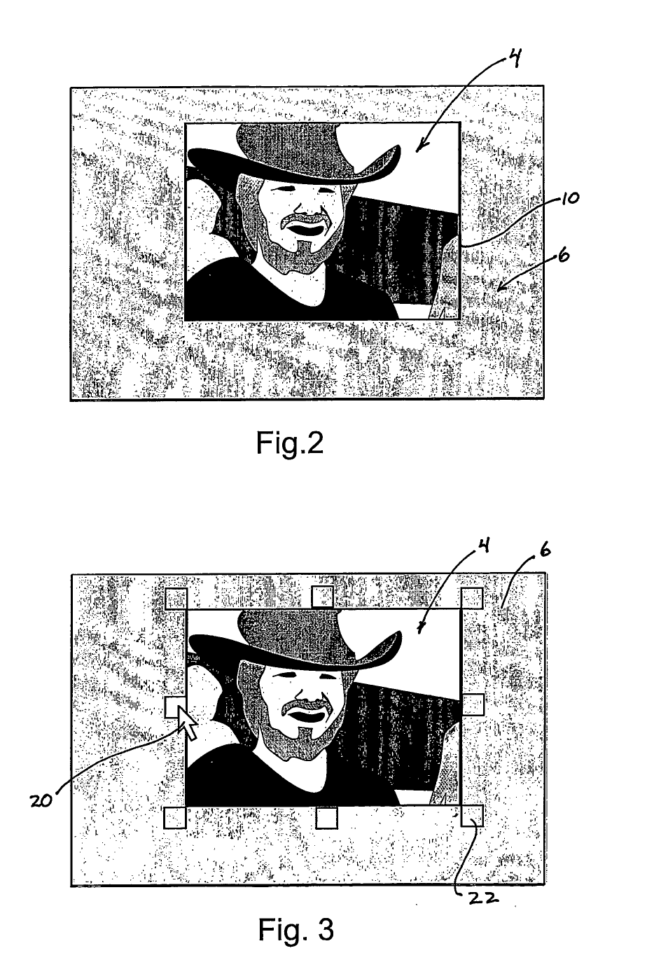

FIG. 2 shows a cropped version of the digital image of FIG. 1. The cropped image is shown as 4 having an obscured region 6 covering up a peripheral frame region of the original digital image. In addition, there is a narrow black frame 10 provided about the cropped digital image. This provides an effective framing about the cropped digital image 4. It can be seen that although the image has been cropped, the aspect ratio has been maintained. This fixed aspect ratio in the preferred embodiment is determined by the user's selection of a desired print size. Adjustment of the cropped image will be accomplished using this fixed aspect ratio.

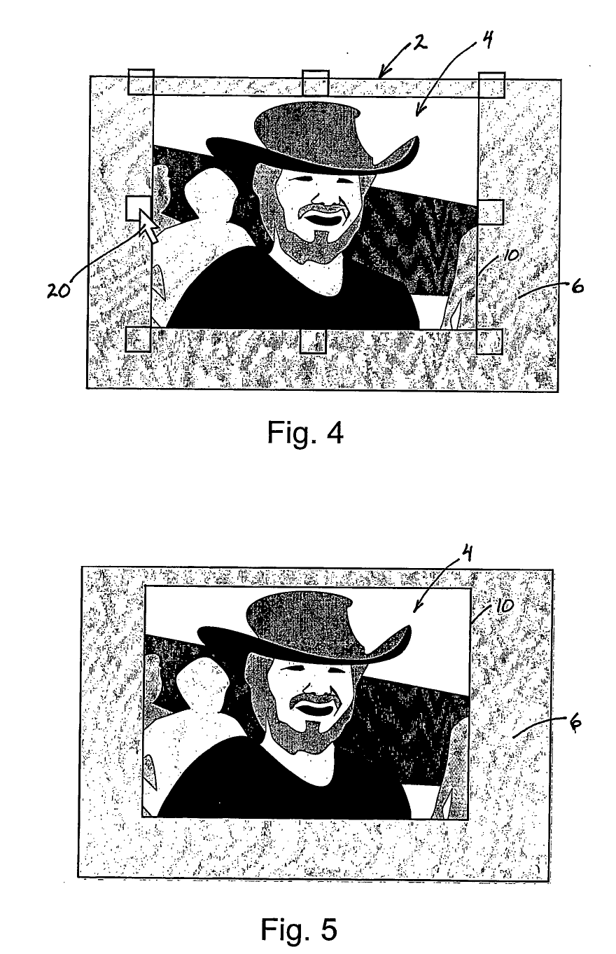

In FIG. 3 the user has moved the mouse arrow 20 onto the digital image and brought forth the cropping tool. The mouse arrow 20 has been positioned over one of the control boxes 22 provided at the corners and mid points of the cropped digital image 4. Clicking of the control box 20 and movement of the mouse with the key depressed has enlarged the cropping frame in both length and width in accordance with the fixed aspect ratio. As a result of this movement, the image of the hat is now fully within the cropped digital image 4 of FIG. 4.

Release of the mouse key produces the display as shown in FIG. 5. In this case, the cropped image 4 is shown together with the new obscured region 6. The cropping tool has been enlarged by movement of the mouse key and positioning of the mouse key over the control boxes 22, however, the actual cropping window can also be moved within the digital image merely by clicking on the image within the frame. Therefore, the cropping window can be increased in size or decreased in size using the fifth aspect ratio and can also be moved about and effectively user placed within the original digital image 2.

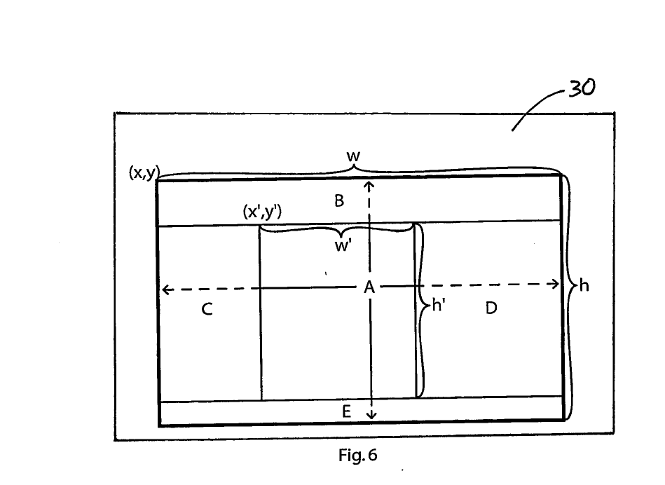

FIG. 6 provides a partial explanation of how the cropped image is displayed and how the obscure regions are provided. In addition, it allows position information with respect to the final cropped digital image to be determined and transmitted. FIG. 6 shows a grey outline 30, which for purposes of discussion will be part of an HTML page. Within this portion 30, an initial start position “XY” is shown and the fixed aspect ratio will define an initial width “W” and an initial height “H”. This is the space that the original digital image 2 of FIG. 1 will be loaded into. Use of the cropping tool will define a new initial position “X,Y−” with a size of “W−,H−”.

The obscured region is defined by four plain coloured image objects; “B, C, D and E”. These are positioned and according to the following formula, in order to appropriately obscure the edges of image “A”,

(B): pos=(x,y); size=(w,y′−y)

(c): pos=(x,y′); size=(x′−x,h′)

(D): pos=(x′+w′,y′); size=(x+w−x′−w′,h′)

(E): pos=(x,y′+h); size=(w,y+h−y′−h′)

The cropping tool application is visually constructed using HTML images sized and layered on top of one another in an HTML page by means of CSS positioning, or some other similar HTML object positioning scheme. The image to be cropped “A”, is assigned to the lowest said-order, so that it can be obscured by other images. The appearance of cropping is simulated by obscuring the edges of the image “A” with plain coloured image objects “B, C, D and E”, layered in front of the image “A”. These plain coloured image objects, “B, C, D, and E”, however, one of four edges of the image “A” is shown in FIG. 6. This creates the impression that the edges of the image have been removed.

User interaction is accomplished by responding to JAVASCRIPT mouse events. Drag operations are implemented by responding to mouse movement events while the mouse button is depressed. The user may signify that he would like to alter the cropped region. This may be done by placing the mouse pointer near a corner of the cropped region then depressing the mouse button and dragging the mouse in such a fashion as to indicate a desired movement of the corner of the cropped region. In response to these actions, the cropping tool repeatedly alters the values of “X−, Y−, W−and/or H−” and repositions objects “B, C, D, and E” according to the formula described above. This procedure has the effect of modifying the display in response to mouse events and create a user interactive cropping session which is carried out quickly and effectively and without repeated action with a server.

It is also possible to provide the cropping tool written in the client sided scripted language such as JAVASCRIPT making use of the table cell function of HTML. In this case the border regions can be defined as an L-shaped peripheral region and two regions. It would also be possible to define the border region as four separate strip regions.

It can also be appreciated that the full digital image need not be entirely obscured. The obscuring objects can merely modify the digital image therebehind to distinguish it from the cropped digital image. In this way, the user has some additional feedback of information that is being removed due to the cropping information. The cropping application maintains its display by creating, destroying, showing, hiding, positioning, and/or repositioning HTML objects. It interacts with the user by responding to client-side scripting events such as mouse movements and/or key press events. This approach minimizes initialization times and avoids the requirement of certain interactive web browser facilities such as JAVA Virtual Machine or a flash plug in which are often unavailable in default web browser configurations.

This cropping tool has particular benefits with respect to digital images where the original aspect ratio is not a multiple of the common print sizes. In this case, some initial cropping is performed to load the digital image into the space provided by the indicated aspect ratio determined by a desired print size. Once the image has been loaded into the appropriate space, the user can then modify the image and provide cropping instructions that will be associated with the digital image. These cropping instructions will include positional information with respect to the size of the digital image to be printed and the portion of the digital image that will be reproduced. This position information is readily available based on the HTML page.

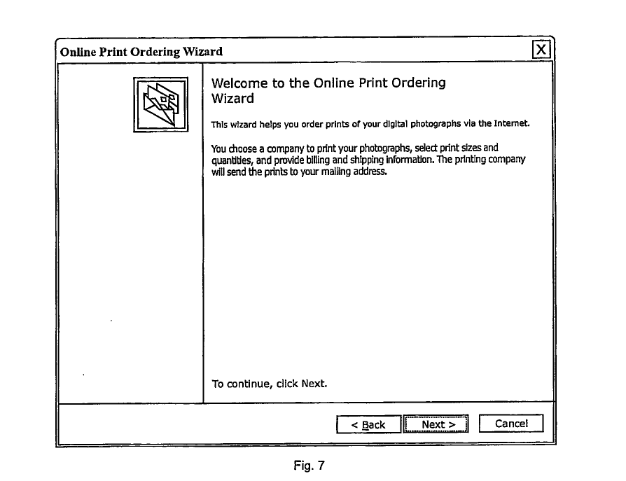

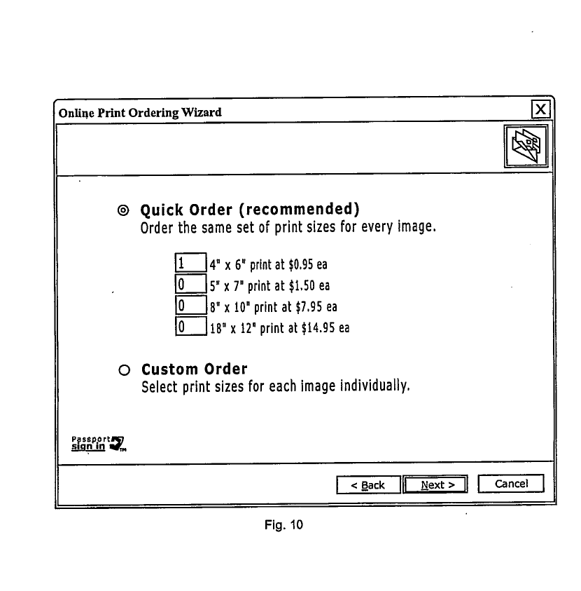

FIGS. 7 through 10 show various screen shots of the online print ordering system.

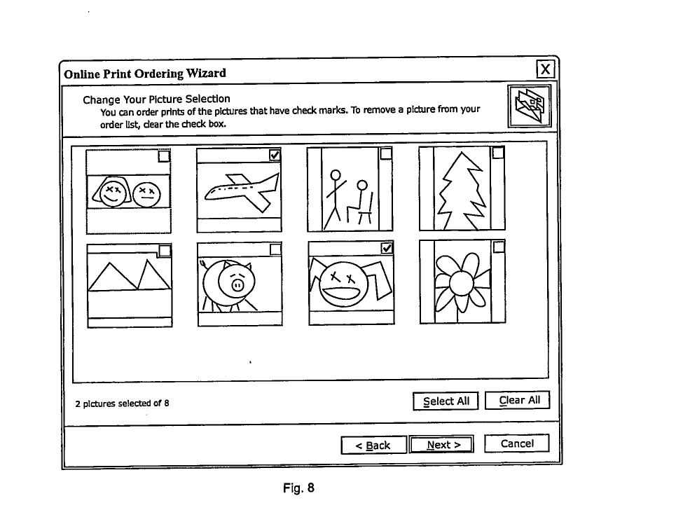

FIG. 7 shows the opening screen when the online Print Ordering Wizard of the operating system is open. It is anticipated that there will be a number of operating systems which will have a standard Print Wizard which allows selection and ordering of prints of digital images. This would be the case of the initial offering of Windows XP™. Therefore, the user upon opening the online Print Ordering Wizard views the initial screen of FIG. 7 and continues with the next screen shown in FIG. 8. In this case, the online Print Wizard has identified a certain series of digital images and has reproduced these digital images in the screen of FIG. 8. As can be seen, there are boxes provided for indicating prints to be ordered.

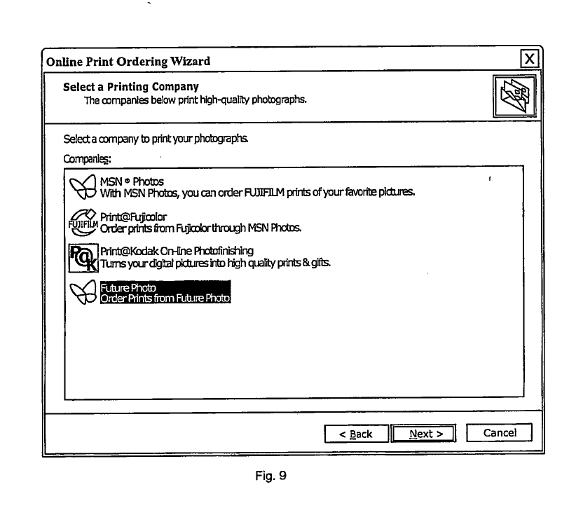

FIG. 9 shows a further screen where the user now indicates which photo services provider he wishes to use. A particular provider is selected and a particular service provider is selected. In this case, Future Photo has been selected and initial contact with the server of Future Photo is carried out. Future Photo allows for photo cropping and a small amount of code is downloaded from the server to the Print Wizard operating on the user's machine. This download is accomplished very quickly as the application is written in JAVASCRIPT and is very compact. The actual crop application is less than 10K and as such, can be quickly downloaded in seconds.

The Print Wizard then produces an order form where the user selects a quick order based on a number of print sizes with each print size having a different fixed aspect ratio. It is also possible to provide a custom order where different size prints are ordered.

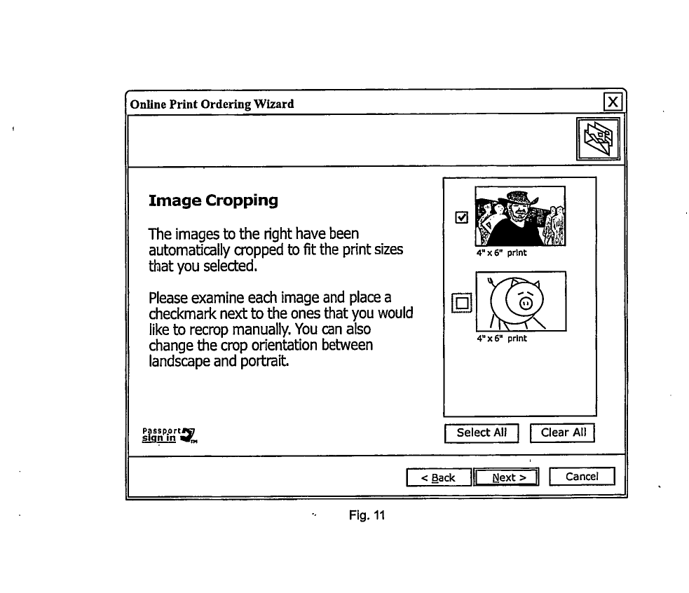

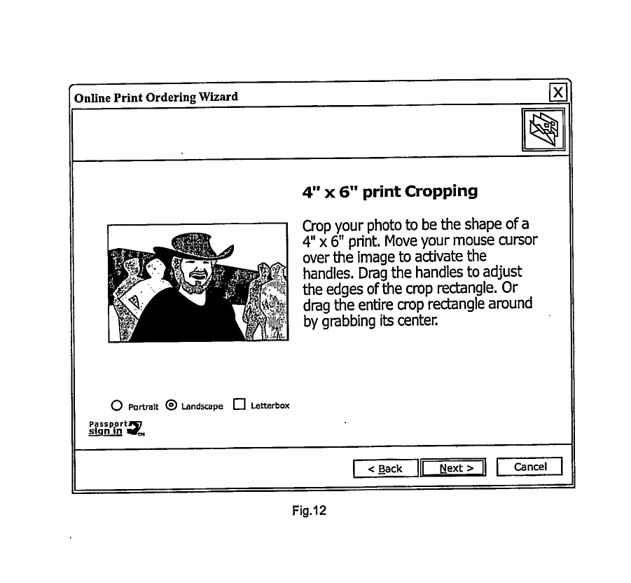

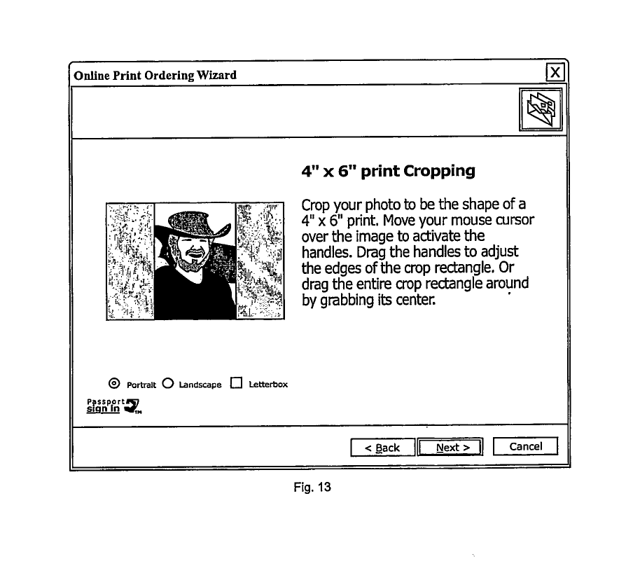

In FIG. 11 an image cropping screen is produced. Two of the images have been previously selected and the images have been automatically cropped to fit the selected print sizes. Boxes are provided to allow individual cropping of the images. In FIG. 11 the top digital image has been indicated as being subject to a manual cropping. This is generally accomplished in the screen of FIG. 12. Screen 12 provides clear instructions regarding the adjustment of the aspect ratio and the selection of the desired portion of the digital image to be printed. The user selects from a series of boxes, either portrait, landscape or letter box and then completes a manual cropping.

FIG. 12 shows where the landscape has been selected by the user whereas in FIG. 13 the user has indicated portrait.

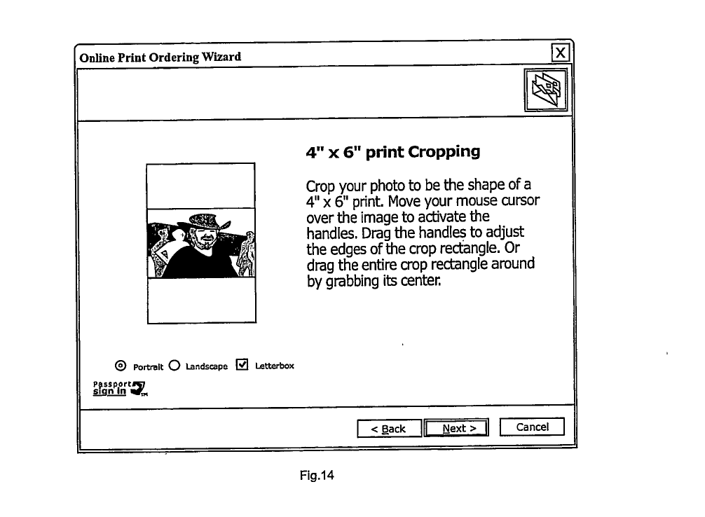

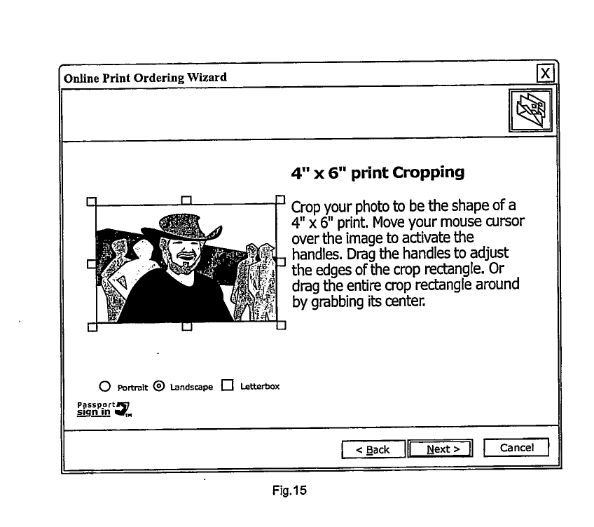

In the screen of FIG. 14, the user has selected letterbox.

In each case the digital image has undergone an initial cropping to fit it in the best manner possible to that desired orientation.

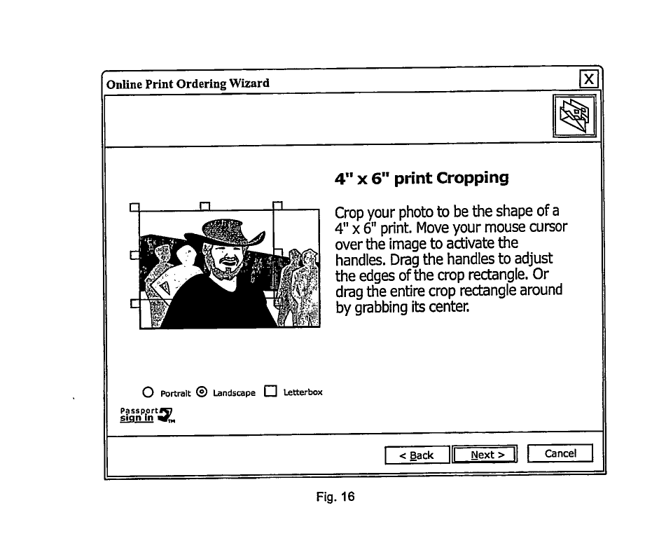

Manual cropping is shown in FIG. 15 through 19 with respect to the second digital image. In this case, a tree is shown in the screen of FIG. 15 and a cropping box is shown about the digital image. The landscape orientation has been selected.

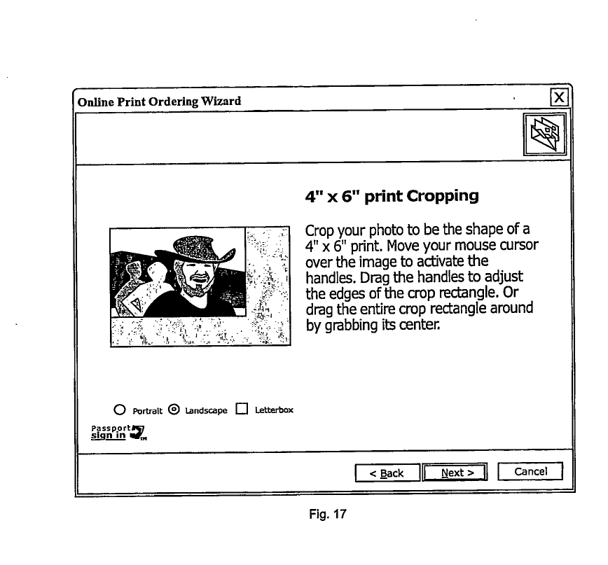

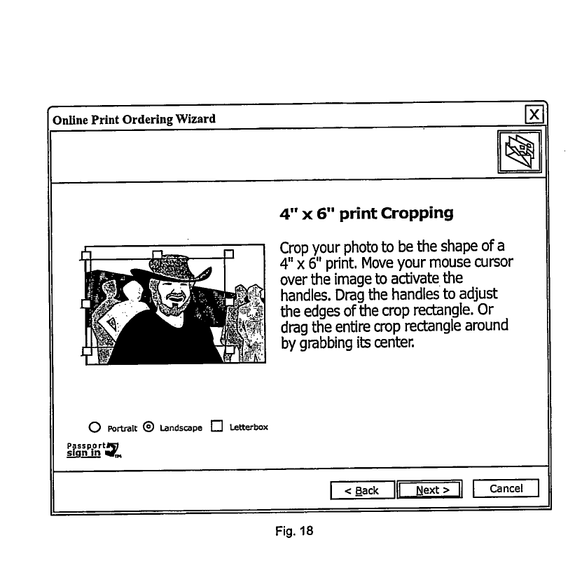

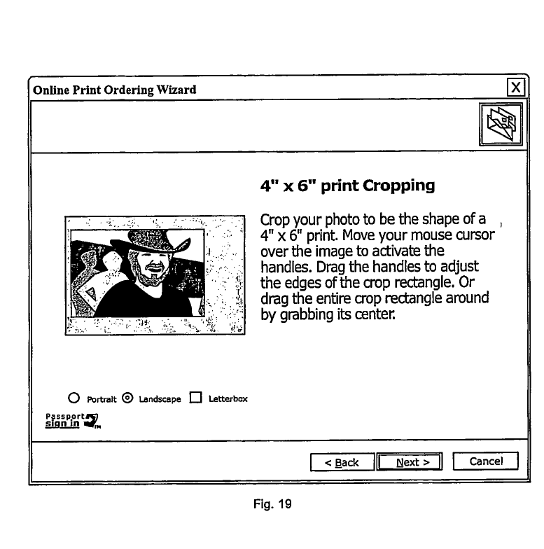

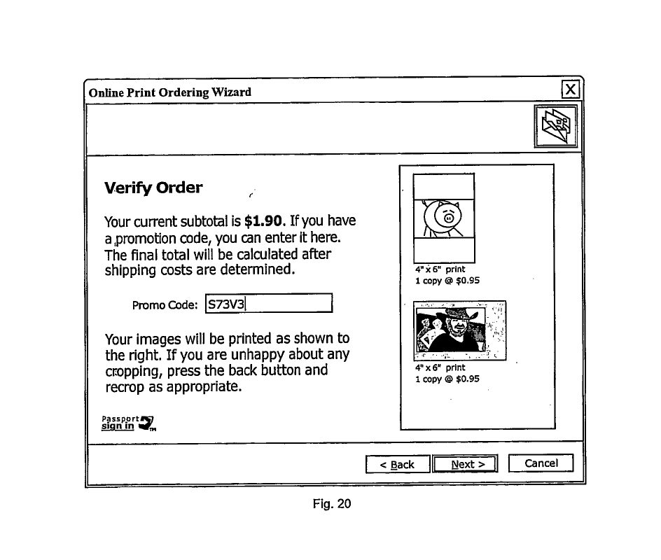

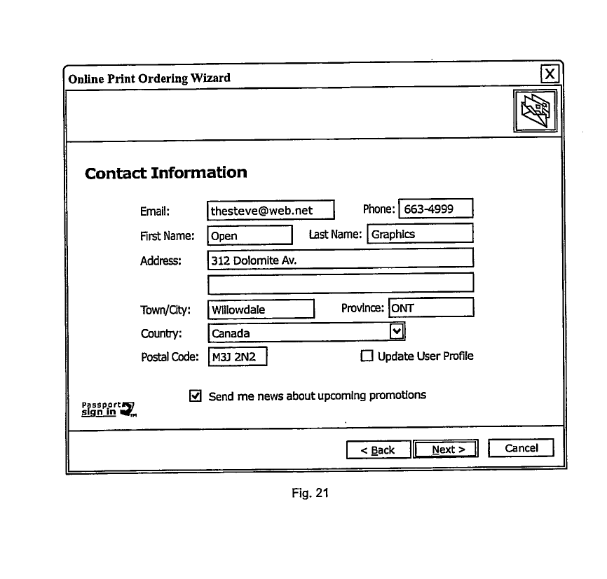

In FIG. 17 the user has adjusted the cropping box by decreasing the size and position thereof. Optionally, the cropping application is also provided with information concerning the resolution of the original image and the minimum resolution required by the print service to fulfill the given print size and uses this information to control the minimum crop area such that the crop of the original image will have sufficient resolution to meet the minimum print requirements of the print service. The result of this cropping operation is shown in FIG. 17. The cropping operation carried out was not to the user's preference and therefore the cropping tool has been brought up in FIG. 18 and the cropping box enlarged. The result of this cropping operation is shown in FIG. 19. This cropping operation produced the desired effect the user was seeking and as such, he now proceeds to the verification of the order shown in the screen of FIG. 20.

The results of his cropping operation are shown on the verification order. The aspect ratio of the final images is correct but the actual print may be enlarged depending on the extent of the crop. The user then approves the order and completes the contact information shown in the screen of FIG. 21.

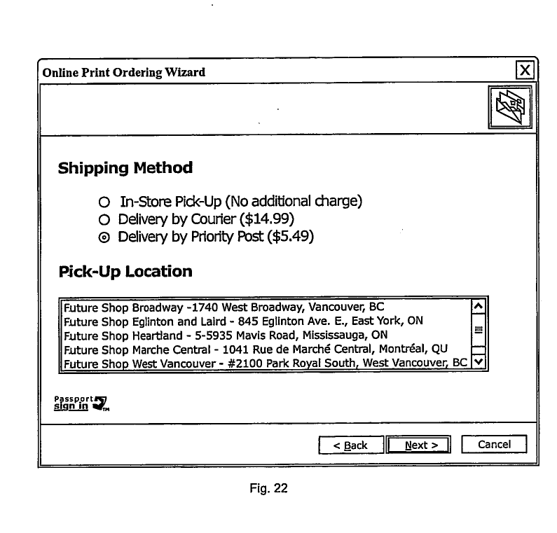

In the screen of FIG. 22 the user selects a desired method for receiving of the prints.

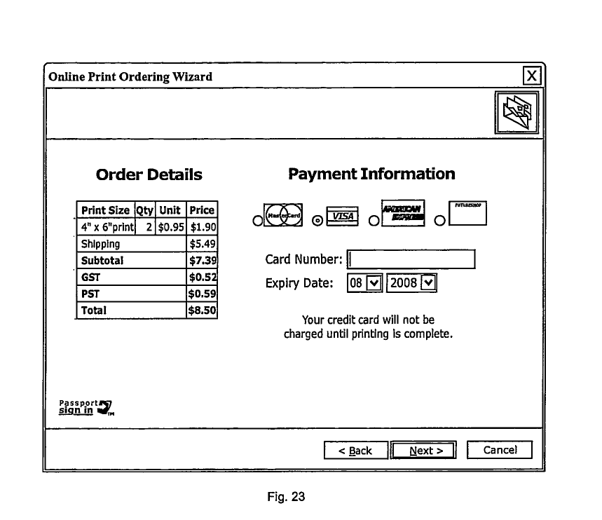

Payment options are provided on the screen of FIG. 23.

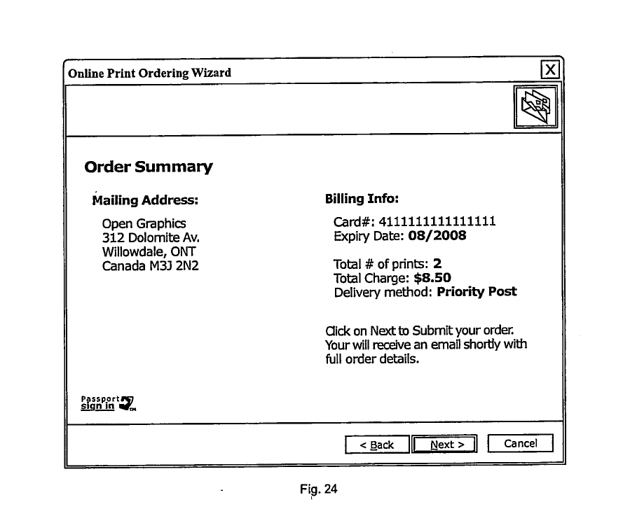

An order summary is provided on the screen of FIG. 24.

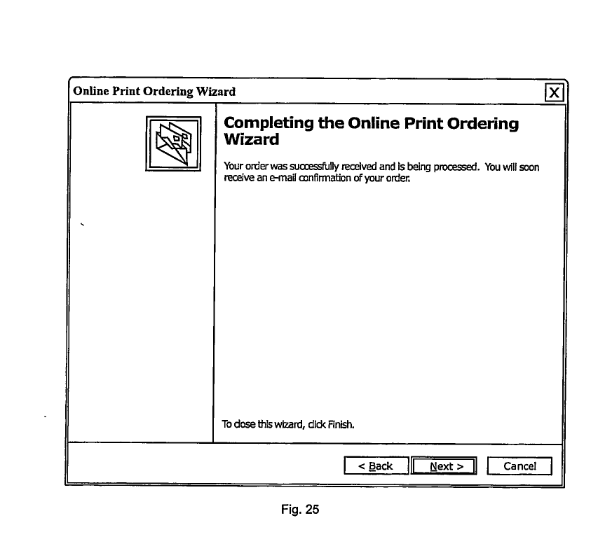

The final screen is provided in FIG. 25 and indicates that an e-mail confirmation will be received shortly.

With the present method and operating system, cropping of the digital images occurs on the user's computer and does not involve extensive exchanges of information from the server to the user's computer. The cropping of the digital image is essentially simulated by obscuring portions of the digital image as indicated by the user and in accordance with a fixed aspect ratio based on other information the user has provided. In many cases the high resolution digital images may be uploaded from the personal computer to the server of the printing company. Only high resolution images that are to be printed are uploaded. In this way, exchange of information is reduced.

The digital image shown in the Print Wizard will typically be proxies of the high resolution images. It is also possible that the high resolution images may be resident on the server of the printing company. For example, the printing company may have developed the original 35 mm film of the user and provided the user with the ability to access these digital images for reordering or cropping. This type of service may be provided for an additional charge or for a temporary period of time. As can be appreciated, the exact location of the high resolution digital images is not material to the operation of the present invention.

The substantial point is that cropping can be provided as an additional feature to a Print Ordering Wizard associated with online digital printing services, regardless of the location of the original image. It is also possible that the operating system provided with personal computers can have within the print wizard, the ability to crop images as generally described herein. The precise method of cropping the images or simulating the effect of a cropped image is not limited to the specific embodiment shown. For some operating systems it is preferable to provide the cropping application as a modification and write the application in JAVASCRIPT. It can be appreciated that another client sided scripted language can be used.

It is also possible that an operating system running on a given personal computer may not have an embedded Print Ordering Wizard, but that such a wizard could be provided as a separate, aftermarket piece of software. To the end user, it would have similar functionality, and in particular, such separate wizard would also be able to be enhanced with the cropping application herein described.

It is also desirable to use the provided features of the HTML protocol of the operating system.

Appendix A is the actual code for the cropper application and Appendix B is this code with comments.

This cropping technique can also be used in the Print Wizard for other transformations such as red eye correction and placement of text. Basically, the area of interest is located using the positioning technique of the cropper tool. The transformation can be added as an overlay on the digital image. Other transformations can use this technique within the Print Wizard.

Print Wizards employing this cropping technique would not necessarily have to run as small windows, but could fill the entire screen and be potentially deployed as dedicated print order kiosks with or without embedded web servers. In the case where such kiosk included an embedded web server, order processing could proceed uninterrupted, even in the even to sporadic network connectivity.

This same technique could be used for a “cell phone image preparation wizard” where the target of the final cropped image would be for display on a cell phone (or similar viewing device including PDS's and digital picture frames), rather than output on a printer. Instead of ordering prints, the wizard would prepare an image for transmission to a cell phone (or PDA, etc.), and correspondingly adjust the resolution and possibly color depth of the region of interest resulting from the cropping action prior to transmission to a given cell phone for display.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive Property or privilege is claimed are defined as follows:

1. A method of cropping a digital image and ordering of the cropped image comprising the steps of
initiating contact with a remote print server over a computer network using personal computer having a print wizard application,
downloading from said remote print server a cropping tool written in a client sided scripted language which modifies said print wizard application to provide a user controlled cropping tool for cropping of digital images;
displaying on said personal computer a digital image and said cropping tool,
receiving user instruction signals from said print wizard and derived from said cropping tool to modify said displayed digital image and selectively obscuring a cropped portion of said digital image and clearly displaying the remaining cropped digital image,
receiving user instruction signals from said print wizard to order a print of said remaining cropped digital image,
transmitting order instructions to said remote print server including cropping instructions which allow said remote print server to fulfill the print order.

2. A method as claimed in claim 1 including the step of having said print server print said cropped digital image.

3. A method as claimed in claim 1 including the step of uploading the original digital image to said print server as part of said order instructions.

4. A method as claimed in claim 3 wherein said original digital image is uploaded to said print server from said personal computer.

5. A method as claimed in claim 1 wherein said cropping tool is written in JAVASCRIPT.

6. A method as claimed in claim 1 wherein said cropping tool responds to client sided scripted events controlled by movement of a mouse of said personal computer.

7. A method as claimed in claim 6 wherein said cropping tool displays a cropping frame having a fixed aspect ratio which is adjusted in size and location by movements of said-mouse.

8. A method as claimed in claim 7 wherein said fixed aspect ratio is selected by the user.

9. A method as claimed in claim 8 wherein said fixed aspect ratio is based on a selected print size.

10. A method as claimed in claim 9 including the step of selecting within said print wizard a desired print orientation.

11. A method as claimed in claim 1 wherein said operating system is WINDOWS XP.

12. A method as claimed in claim 1 wherein said personal computer is a cell phone or is a PDA device.

13. A method as claimed in claim 1 wherein said cropping tool displays said cropped region as a translucent region overlying said digital image.

14. A method as claimed in claim 1 wherein said cropping tool displays said cropped region as an opaque region overlying said digital image.

15. A method as claimed in claim 1 wherein said step of downloading is accomplished in less than 2 seconds.

16. A method as claimed in claim 1 wherein said cropping tool requires less than 10 k of memory.

17. An operating system for a personal computer said operating system including a print wizard for printing of digital images, said print wizard including a user adjustable cropping tool, said print wizard displaying a digital image with said cropping tool and responding to user events of said cropping tool to display a cropped image for user approval, said print wizard including an instruction command to order a cropped image, said print wizard in response to said instruction command determining a print order instruction set which includes cropping instructions for said cropped image which provide position information of the portion of the digital image to be used in printing of the cropped image.

18. A method as claimed in claim 1 wherein said cropping application would provide cropping information to an enhanced print wizard to automatically upload only the region of interest of the original image.

19. A method as claimed in claim 18 wherein said enhanced print wizard also reduces the resolution of the region of interest to meet the minimum desired resolution requirements of the print service for a given desired print size.

20. A method as claimed in claim 1 wherein said cropping tool receives resolution information about the original image from the print wizard or other function and uses such information in conjunction with information from the print server to prevent a user from cropping an image such that the cropped area represents less resolution than the minimum accepted by the print service for a given desired print size.

21. A method as claimed in claim 1 wherein said print wizard covers all or substantially all the computer display screen area to function as a print order kiosk.

22. A method as claimed in claim 21 wherein said remote print server actually resides as part of the system operating said print wizard either within the same computer or as a locally attached server such that in any case, said print order kiosk can perform print order functions even if an attached network has failed.

23. A method of cropping a digital image and ordering of the cropped image comprising the steps of
using a personal computer equipped with an operating system having an embedded or aftermarket print wizard application to initiate contact with a remote image server connected to said personal computer by a computer network,
downloading from said image server a cropping tool written in a client sided scripted language which modifies said print wizard application to provide a user controlled cropping tool for cropping of digital images,
displaying on said personal computer a digital image and said cropping tool,
receiving user instruction signals from said image server, print wizard, and derived from said cropping tool to modify said displayed digital image and selectively obscuring a cropped portion of said digital image and clearly displaying the remaining cropped digital image, based on image requirements of a target device such as a cell phone, PDA or digital picture frame,
receiving user instruction signals from said print wizard to associate a given image to a specific target device for display,
transmitting associating instructions to said remote image server including cropping instructions which allow said remote image server to further transmit the digital image for display on said target device.

24. A method as claimed in claim 23 including the step of having said print server print said cropped digital image.

25. A method as claimed in claim 23 including the step of uploading the original digital image to said image server as part of said associating instructions.

26. A method as claimed in claim 25 wherein said original digital image is uploaded to said image server from said personal computer.

27. A method as claimed in claim 23 wherein said cropping tool is written in JAVASCRIPT.

28. A method as claimed in claim 23 wherein said cropping tool responds to client sided scripted events controlled by movement of a mouse of said personal computer.

29. A method as claimed in claim 28 wherein said cropping tool displays a cropping frame having a fixed aspect ratio which is adjusted in size and location by movements of said mouse.

30. A method as claimed in claim 29 wherein said fixed aspect ratio is selected by the user.

31. A method as claimed in claim 30 wherein said fixed aspect ratio is based on the target device's display size.

32. A method as claimed in claim 31 including the step of selecting within said print wizard a desired image orientation.

33. A method as claimed in claim 23 wherein said operating system is WINDOWS XP.
